(19) United States
(12) Patent Application Publication
(10) Pub. No.: US 2015/0339926 A1
(43) Pub. Date: Nov. 26, 2015

(54) Traffic warning apparatus and traffic warning method for warning traffic participants about a hazard region

(71) Applicant: Robert Bosch GmbH, Stuttgart (DE)

(72) Inventors: Corinna LANGE, Hannover (DE); Esther-Sabrina WACKER, Hildesheim (DE); Joerg HILSEBECHER, Hildesheim (DE)

(21) Appl. No.: 14/717,529

(22) Filed: May 20, 2015

(30) Foreign Application Priority Data
May 22, 2014 (DE) 10 2014 209 791.6

(51) Int. Cl. G08G 1/16

(52) U.S. Cl. CPC G08G 1/166

(57) ABSTRACT

A traffic warning apparatus for a vehicle for warning traffic participants about a hazard region, having a sensor device that is embodied to sense a directional change of the vehicle, having an evaluation device that is embodied to identify a hazard region that ensues for other traffic participants as a result of the directional change of the vehicle, having a visualization device, mounted on the vehicle, that is embodied to visualize the hazard region for other traffic participants outside the vehicle. Also described is a traffic warning method for warning traffic participants about a hazard region.

### CROSS REFERENCE TO RELATED APPLICATION

The present application claims priority to Application No. DE 10 2014 209 791.6, filed in the Federal Republic of Germany on May 22, 2014, which is incorporated herein in its entirety by reference thereto.

### FIELD OF INVENTION

The present invention relates to a traffic warning apparatus and to a traffic warning method for warning traffic participants about a hazard region.

### BACKGROUND INFORMATION

Long vehicles often slew out into adjacent lanes, for example, when turning or otherwise changing direction, and thereby endanger other traffic participants. This slewing is often not apparent to and predictable by, in particular, vehicles in adjacent lanes, resulting in a greatly elevated risk of an accident.

Top-view systems at present allow the driver of the vehicle to predict and visualize his driving track or that of the entire combination. This information is at present reserved exclusively for the driver, however, and is not known to the other traffic participants.

German patent application DE 10 2008 036 009 A1 discusses a method for generating an image of the surroundings of a motor vehicle in terms of a virtual camera position from the images of at least one camera disposed on the motor vehicle, a transposition of the camera images to the virtual camera position being accomplished, the camera images being corrected by adding further information regarding the surroundings of the motor vehicle.

### SUMMARY OF THE INVENTION

The present invention creates a traffic warning apparatus, having the features described herein, for warning traffic participants about a hazard region, and a traffic warning method, having the features described herein, for warning traffic participants about a hazard region.

The following are accordingly provided:

A traffic warning apparatus for a vehicle for warning traffic participants about a hazard region, having a sensor device that is embodied to sense a directional change of the vehicle, having an evaluation device that is embodied to identify a hazard region that ensues for other traffic participants as a result of the sensed directional change of the vehicle, having a visualization device, mounted on the vehicle, that is embodied to visualize the hazard region for other traffic participants outside the vehicle.

A traffic warning method for warning traffic participants about a hazard region is furthermore made available, having the following method steps:

(S1) sensing, by way of a sensor device, a directional change of a vehicle,

(S2) identifying, by way of an evaluation device, a hazard region that ensues for other traffic participants as a result of the sensed directional change of the vehicle,

(S3) visualizing the hazard region, by way of a visualization device mounted on the vehicle, for other traffic participants outside the vehicle.

Refinements are the subject matter of the further descriptions herein.

The idea on which the present invention is based is to provide, in the context of a traffic warning apparatus, a visualization device that is embodied to visualize the hazard region for other traffic participants on the basis of a sensed directional change of the vehicle.

The visualization device allows the hazard region resulting from the directional change of the vehicle to be presented to other traffic participants who, thanks to this additional information, can react better to the directional change of the vehicle and can take appropriate measures. This traffic warning apparatus allows road traffic safety to be appreciably enhanced, since fewer serious accidents occur.

According to an embodiment of the present invention the sensor device is embodied to sense the directional change of the vehicle on the basis of an actuation of a directional indicator of the vehicle. For example, the sensor device recognizes that the driver of the vehicle is actuating the right directional indicator in order to indicate to other traffic participants that the vehicle will turn right, and is performing a directional change. The evaluation device thereupon identifies a hazard region that results from the directional change. The visualization device thereupon indicates to the other traffic participants that the vehicle will swing out to the left. For example, the visualization device projects onto the left region of the roadway the hazard region that is produced by the turning of the vehicle. The traffic warning device can in this manner be embodied very economically and simply.

According to a further embodiment of the present invention the sensor device is embodied to sense the directional change of the vehicle on the basis of a steering angle of the vehicle. For example, an angle sensor is disposed on the steering wheel, on the wheels, and/or on the drawbar of the vehicle and is coupled to the sensor device in order to sense the directional change of the vehicle. This embodiment of the traffic warning apparatus allows the directional change of the vehicle to be sensed even more precisely and particularly quickly.

According to a further embodiment of the present invention the sensor device is embodied to sense the directional change of the vehicle on the basis of an acceleration or yaw rate of the vehicle. For example, a piezoelectric acceleration sensor or yaw rate sensor is disposed on the vehicle and is coupled to the sensor device. The acceleration sensor can also, however, be based on a different measurement principle. This embodiment of the traffic warning apparatus allows the directional change of the vehicle, and thus the hazard region, to be sensed and identified even more accurately.

According to a further embodiment of the present invention the sensor device is embodied to receive a Global Positioning System (GPS) signal and to sense the directional change of the vehicle on the basis of the received GPS signal. This embodiment of the traffic warning apparatus allows sensing of the directional change to be effected very accurately.

According to a further embodiment of the present invention the sensor device is coupled to a driver assistance system in the vehicle and is embodied to sense the directional change of the vehicle based on a signal of the driver assistance system. For example, the sensor device is coupled to a parking aid of the vehicle which has cameras and/or distance sensors. This embodiment of the traffic warning apparatus allows the traffic warning apparatus to be manufactured very economically, since devices already present in the vehicle can be used.

According to a further embodiment of the present invention the visualization device encompasses a projector that is embodied to project the hazard region onto the roadway. For example, the sensor device encompasses a laser projector, an incident-light projector, and/or a transmitted-light projector that is embodied to project the hazard region onto the roadway. The entire hazard region, or only the outer edge of the hazard region, can be projected onto the roadway. Advantageously, projection is accomplished in a signal color, for example red, yellow, and/or orange. Furthermore, the projector can also project additional information, for example characters and/or words, onto the roadway. For example, the visualization device could project the words “Caution,” “Danger,” or “Vehicle turns wide” onto the roadway. The projection of symbols, such as the “danger zone” traffic symbol, would also be particularly helpful.

According to a further embodiment of the present invention the visualization device encompasses a light-emitting arrangement that are disposed on the vehicle. For example, light-emitting diodes or incandescent lamps, which can visualize the hazard region to other traffic participants, are mounted on the vehicle. The light-emitting arrangement can be disposed on each side of the vehicle, so that the hazard region is readily visible from all sides.

According to a further embodiment of the present invention the visualization device encompasses a display that is disposed on the vehicle. Displays that visualize the hazard region to the other traffic participants are disposed, for example, on the rear side, the front side, and/or the lateral surfaces of the vehicle.

According to a further embodiment of the present invention the evaluation device is embodied to identify the hazard region on the basis of the length of the vehicle and/or the width of the vehicle. Further criteria that relate to information regarding the vehicle, to the directional change, and/or to the surroundings of the vehicle can also be utilized for identification of the hazard region.

The attached drawings are intended to contribute to further understanding of the embodiments of the invention. They illustrate embodiments, and in conjunction with the description serve to explain principles and concepts of the invention.

Other embodiments, and many of the advantages mentioned, may be gathered from the drawings. The elements depicted in the drawings are not necessarily shown at correct scale with one another.

In the Figures of the drawings, identical reference characters designate identical or functionally identical elements, constituents, or components unless indicated to the contrary.

### BRIEF DESCRIPTION OF THE DRAWINGS

FIG. 1 is a schematic block diagram of a traffic warning apparatus according to an embodiment of the present invention.

FIG. 2 is a schematic plan view of a vehicle having a traffic warning apparatus according to a further embodiment of the present invention.

FIG. 3 is a schematic plan view of a vehicle having a traffic warning apparatus according to a further embodiment of the present invention.

FIG. 4 is a schematic plan view of a vehicle having a traffic warning apparatus according to a further embodiment of the present invention.

FIG. 5 is a schematic plan view of a vehicle having a traffic warning apparatus according to a further embodiment of the present invention.

FIG. 6 is a schematic plan view of a vehicle having a traffic warning apparatus according to a further embodiment of the present invention.

FIG. 7 is a schematic plan view of a vehicle having a traffic warning apparatus according to a further embodiment of the present invention.

FIG. 8 is a schematic flow chart of a traffic warning method according to an embodiment of the present invention.

### DETAILED DESCRIPTION

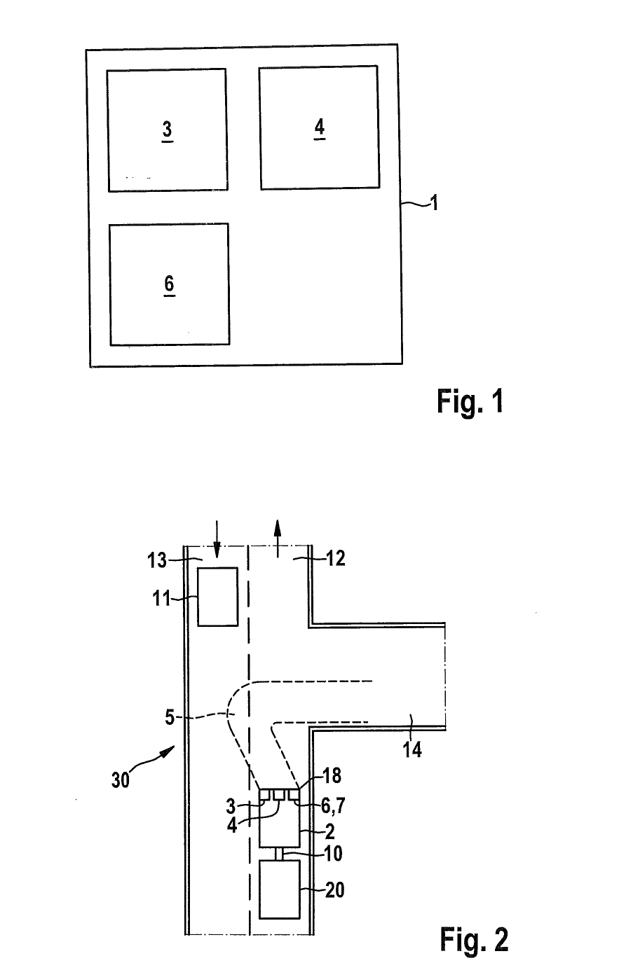

FIG. 1 is a schematic block diagram showing a traffic warning apparatus 1 according to an embodiment of the present invention. Traffic warning apparatus 1 for a vehicle, for warning traffic participants about a hazard region, has a sensor device 3 that is embodied to sense a directional change of the vehicle. Sensor device 3 is embodied, for example, to sense the directional change of the vehicle on the basis of an actuation of a directional indicator. It is furthermore possible for sensor device 3 to be embodied to sense the directional change of the vehicle on the basis of a steering angle of the vehicle. It would likewise be conceivable for the sensor device to be embodied to sense the directional change of the vehicle on the basis of an acceleration of the vehicle.

Traffic warning apparatus 1 furthermore has an evaluation device 4 that is embodied to identify a hazard region that ensues for other traffic participants as a result of the sensed directional change of the vehicle. For example, evaluation device 4 is embodied to identify the hazard region on the basis of the length of the vehicle and/or the width of the vehicle. Evaluation device 4 can be embodied, for example, as a microcontroller or can be embodied in computer-implemented fashion in the vehicle electronic system.

Traffic warning apparatus 1 furthermore has a visualization device 6 that is mounted on the vehicle. Visualization device 6 is embodied to visualize the hazard region for other traffic participants outside the vehicle. Visualization device 6 encompasses, for example, a projector 7 that is embodied to project the hazard region onto the roadway. Visualization device 6 could furthermore encompass a light-emitting arrangement disposed on the vehicle. It is likewise possible for visualization device 6 to encompass a display that is disposed on the vehicle.

Visualization device 6 allows the hazard region resulting from the sensed directional change of the vehicle to be presented to other traffic participants who, thanks to this additional information, can react better to the directional change of the vehicle and can take appropriate measures. Road traffic safety can thereby be appreciably enhanced, since because of the traffic warning apparatus, appreciably fewer serious accidents occur.

FIG. 2 is a schematic plan view of a vehicle 2 having a traffic warning apparatus 1′ according to a further embodiment of the present invention. FIG. 2 depicts a roadway intersection 30 that encompasses roadways 12, 13, and 14. Roadways 12 and 13 represent an ordinary road on which vehicles 2, 11 move in both directions. The direction of travel of roadways 12 and 13 is depicted by arrows. Roadway 14 branches off from roadway 12.

A vehicle 2 is located on roadway 12. Vehicle 2 has a drawbar 10 on which a trailer 20 is located. Vehicle 2 is very long, e.g. 15 to 20 meters long. In the context of a turning operation onto roadway 14, it is therefore necessary for vehicle 2 to swing out to the left side in order to be able to turn into roadway 14.

Located on roadway 13 is a traffic participant 11, for example a motor vehicle, that could be affected by the swinging out of vehicle 2 toward the left side.

Vehicle 2 has a traffic warning apparatus 1′ that encompasses a sensor device 3, an evaluation device 4, and a visualization device 6.

Sensor device 3 is embodied, for example, to sense the directional change of vehicle 2 on the basis of an actuation of a directional indicator 18 of vehicle 2. For example, sensor device 3 senses the actuation of directional indicator 18 on the right side of vehicle 2. Evaluation device 4 can then, on the basis of the actuation of directional indicator 18 of the vehicle, identify a hazard region 5 that ensues for traffic participant 11 as a result of the directional change of vehicle 2.

Evaluation device 4 determines that for a turning operation to the right, a swing out to the left is necessary. Evaluation device 4 is therefore embodied to identify a hazard region 5.

Traffic warning apparatus 1 furthermore encompasses a visualization device 6 that is embodied to visualize the hazard region for other traffic participants 11 outside vehicle 2. In the embodiment of traffic warning apparatus 1′ which is depicted, traffic warning apparatus 1′ encompasses a projector 7 that is embodied to project hazard region 5 onto roadways 12, 13, and 14. Projector 7 is embodied, for example, as a laser projector, and is embodied to make hazard region 5 apparent to other traffic participants 11 on roadways 12, 13, and 14 in a red color.

In this manner, for example, traffic participant 11 detects the swinging-out operation of vehicle 2 in timely fashion and can react accordingly. Thanks to the information depicted, traffic participant 11 can, for example, decrease his or her speed so that vehicle 2 can complete its turning operation without difficulty.

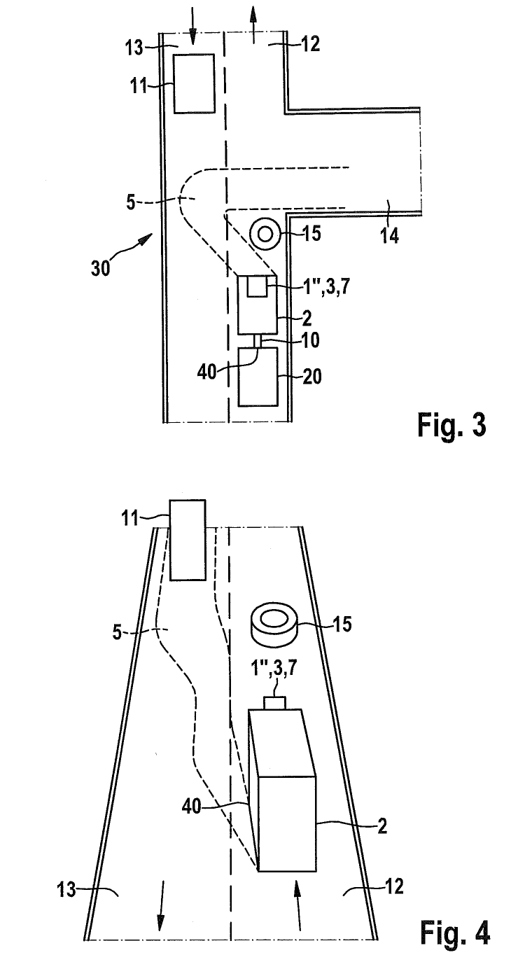

FIG. 3 is a schematic plan view of a vehicle 2 having a traffic warning apparatus 1″ according to a further embodiment of the present invention. Unlike in the traffic situation depicted in FIG. 2, an obstacle 15 is additionally located on roadway 12 just before intersection 30. In addition, traffic warning apparatus 1″ is equipped with a sensor apparatus 3 that is embodied to sense the directional change of vehicle 2 on the basis of an acceleration of vehicle 2. For example, sensor device 3 senses a strong acceleration to the left. Hazard region 5 is identified on the basis of the acceleration. As compared with the situation depicted in FIG. 2, it is evident that vehicle 2 must swing out farther to the left in order to carry out a turning operation to the right. Hazard region 5 identified by evaluation device 4 is projected by way of projector 7 onto the roadway so that a hazard region 16 is depicted on roadways 12, 13, and 14 and can be detected.

FIG. 4 is a schematic plan view of a vehicle 2 having a traffic warning apparatus 1′″ according to a further embodiment of the present invention. FIG. 4 depicts a two-lane road that has a roadway 12 on the right side and a roadway 13 on the left side. The vehicles on roadway 12 are moving in the opposite direction from the vehicles that are moving on roadway 13.

Located on roadway 12 is a vehicle 2 that is equipped with a traffic warning apparatus 1′″ according to an embodiment of the present invention. An obstacle 15 is also located on roadway 12. Traffic warning apparatus 1′″ is equipped with an acceleration sensor that is embodied to sense an acceleration of vehicle 2. Traffic warning apparatus 1′″ furthermore has an angle sensor 40 that is embodied to identify the steering angle of vehicle 2. This angle sensor 40 is likewise coupled to sensor device 3. Sensor device 3 and visualization apparatus 6, which in this embodiment is embodied as a projector 7, are accommodated in a one-piece housing that is located on the roof of vehicle 2. As a result of the sensing of the directional change of vehicle 2 by way of sensor device 3, a hazard region is identified and is projected by way of projector 7 onto roadway 13 and onto roadway 12. A vehicle 11, which represents another traffic participant, is warned by the projected hazard region 5 so that traffic participant 11 can react correspondingly.

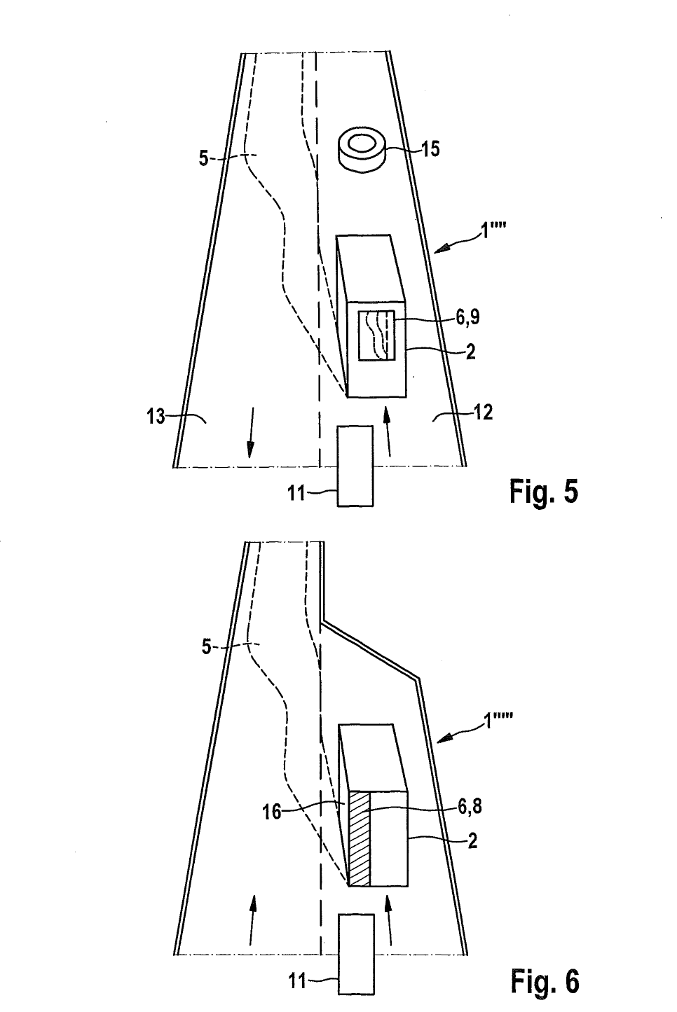

FIG. 5 is a schematic plan view of a vehicle having a traffic warning apparatus 1″″ according to a further embodiment of the present invention. In the embodiment depicted, visualization device 6 encompasses a display 9. A display 9, which visualizes hazard region 5 identified by evaluation device 4 for other traffic participants 11 outside vehicle 2, is disposed, for example, on the rear side of vehicle 2. Display 9 can be embodied, for example, as a TFT screen or LED screen, and can visualize hazard region 5 to other traffic participants. In the embodiment depicted, display 9 is disposed on the rear side of vehicle 2, but display 9 can also be disposed on the side, on the front, and/or at another readily visible location on vehicle 2.

In the embodiment depicted, vehicle 2 is moving to the left because of an obstacle 15. Evaluation device 4 identifies hazard region 5 that ensues as a result of the directional change of vehicle 2. Hazard region 5 identified by evaluation device 4 is displayed on display 9 in a simplified depiction.

It is thereby possible for other traffic participants 11 to adjust their driving behavior to hazard region 5.

FIG. 6 shows a further embodiment of traffic warning apparatus 1′″″ according to an embodiment of the present invention. In the embodiment depicted, visualization apparatus 6 encompasses a light-emitting arrangement 8 disposed on vehicle 2. For example, visualization apparatus 6 encompasses an LED matrix 8 that is disposed on the outer surface of vehicle 2. In the traffic situation depicted, sensor device 3 senses a directional change of vehicle 2. For example, sensor device 3 recognizes that the driving lane will become narrower, and that a lane change must occur. A hazard region 5 is identified on the basis of the sensed sensor values that can be sensed, for example, by a Global Positioning System (GPS) that sensor device 3 encompasses. Visualization device 6 is embodied to present hazard region 5 optically to other traffic participants 11. The other traffic participant 11 can thereby react proactively to the lane change of vehicle 2.

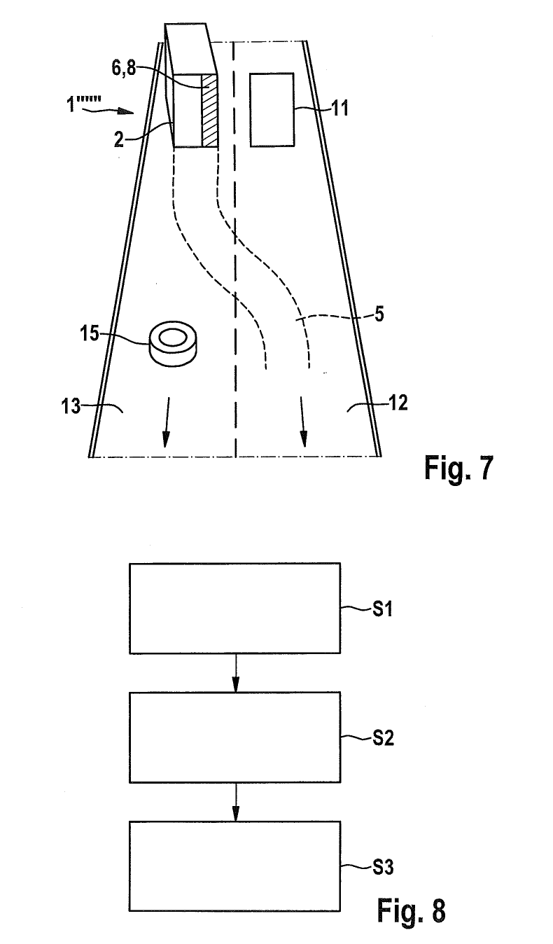

FIG. 7 is a schematic plan view of a vehicle 2 having a traffic warning apparatus 1″″− according to a further embodiment of the present invention. In the embodiment depicted, visualization device 6 is disposed on the front side of vehicle 2. Roadway 12 in FIG. 7 is a two-lane road on which vehicles move in the same direction. In the case of an evasive maneuver by vehicle 2 due to an obstacle 15, the directional change of vehicle 2 is sensed by sensor device 3. Evaluation device 4 identifies a hazard region 5 that ensues for other traffic participants 11 as a result of the directional change of vehicle 2. Visualization device 6, which is embodied on the front side of vehicle 2 by light-emitting arrangement 8, can visualize hazard region 5 for the other traffic participants 11. The other traffic participants 11 can therefore adapt their driving behavior to hazard region 5.

FIG. 8 is a schematic flow chart of a traffic warning method for warning traffic participants about a hazard region 5. In a first method step S1, a directional change of a vehicle 2 is sensed by way of a sensor device 3. In a further method step S2, a hazard region 5 that ensues for other traffic participants 11 as a result of the sensed directional change of vehicle 2 is identified by way of an evaluation device 4. In a third traffic warning method step S3, hazard region 5 is visualized for other traffic participants outside vehicle 2 by way of a visualization device 6 mounted on vehicle 2. Further traffic warning method steps can be introduced between method steps S1, S2, and S3, and/or further method steps can precede or can be appended.

Although the present invention has been described above with reference to exemplary embodiments, it is not limited thereto but instead is modifiable in numerous ways. In particular, the invention can be changed or modified in a multiplicity of ways without deviating from the essence of the invention.

What is claimed is:

1. A traffic warning apparatus for a vehicle for warning traffic participants about a hazard region, comprising:
a sensor device to sense a directional change of the vehicle;
an evaluation device to identify a hazard region that ensues for other traffic participants as a result of the directional change of the vehicle; and
a visualization device, mounted on the vehicle, to visualize the hazard region for other traffic participants outside the vehicle.

2. The traffic warning apparatus of claim 1, wherein the sensor device is configured to sense the directional change of the vehicle based on an actuation of a directional indicator of the vehicle.

3. The traffic warning apparatus of claim 1, wherein the sensor device (3) is configured to sense the directional change of the vehicle (2) on the basis of a steering angle (11) of the vehicle (2).

4. The traffic warning apparatus of claim 1, wherein the sensor device is configured to sense the directional change of the vehicle based on an acceleration of the vehicle (2).

5. The traffic warning apparatus of claim 1, wherein the sensor device is configured to receive a GPS signal and to sense the directional change of the vehicle based on the received GPS signal.

6. The traffic warning apparatus of claim 1, wherein the visualization device includes a projector that is configured to project the hazard region onto the roadway.

7. The traffic warning apparatus of claim 1, wherein the visualization device includes a light-emitting arrangement that is disposed on the vehicle.

8. The traffic warning apparatus of claim 1, wherein the visualization device includes a display that is disposed on the vehicle.

9. The traffic warning apparatus of claim 1, wherein the evaluation device is configured to identify the hazard region based on at least one of a length and a width of the vehicle.

10. A traffic warning method for warning traffic participants about a hazard region, the method comprising:
sensing, by a sensor device, a directional change of a vehicle;
identifying, by an evaluation device, a hazard region that ensues for other traffic participants as a result of the sensed directional change of the vehicle; and
visualizing the hazard region, by a visualization device mounted on the vehicle, for other traffic participants outside the vehicle.
